(19) United States
(12) Patent Application Publication
(10) Pub. No.: US 2002/0026397 A1
(43) Pub. Date: Feb. 28, 2002

(54) Method for managing card information in a data center

(76) Inventors: Kaname Ieta, Atsugi (JP); Natsuro Tanaka, Atsugi (JP); Toshinori Obata, Hadano (JP)

Correspondence Address: MATTINGLY, STANGER & MALUR, P.C., ATTORNEYS AT LAW, 104 EAST HUME AVENUE, ALEXANDRIA, VA, 22301, US

(21) Appl. No.: 09/795,111

(22) Filed: Mar. 1, 2001

(30) Foreign Application Priority Data
Aug. 23, 2000 (JP) 2000-258128

(51) Int. Cl. G06F 17/60

(52) U.S. Cl. 705/35

(57) ABSTRACT

Card information is managed in a data center interposed between a plurality of financial institutions which issue cards and users which use the issued cards. The data center registers card information including card numbers and card status information into a database correspondingly to user IDs established in advance. The data center checks a user ID transmitted from a terminal operated by corresponding one of the users with each of user IDs registered in the database. As a result of the checking, if there is a registered user ID coinciding with the transmitted user ID, the data center invalidates card status information corresponding to at least one card selected by the user out of card information of the user. Then, the data center transmits a request to invalidate the selected card to a corresponding financial institution which has issued the selected card while designating card number of the card.

### BACKGROUND OF THE INVENTION

The present invention relates to a card management system and a method for managing card information. Particularly the present invention relates to a system and a method for invalidating a card, which use a network system to manage, in a lump, personal information of cards issued by financial institutions such as banks, credit companies, etc., and to carry out management about cards, for example, management for invalidating cards in place of users.

Cashless settlement for making a purchase or payment through a card is carried out routinely. In addition, recently, a person for the most part always has a plurality of cards from various credit companies and a plurality of cards for various bank accounts.

Such a user having a plurality of cards may sometimes lose a plurality of cards at one time. In such a case, in order to prevent a third party finder of the cards from using the cards illegitimately, the user has to make contact with a plurality of financial institutions one by one by telephone or the like on the basis of card management information managed by the user to thereby take procedures for invalidating the cards.

However, few users manage their card information of a plurality of financial institutions in order. In addition, it is complicated and troublesome to take procedures for invalidating cards to a plurality of different financial institutions one by one. To prevent any third person from using the cards illegitimately, it is indeed important to take procedures to invalidate the cards as soon as possible. But, depending on management of the card information made by the user, procedures taken by the user for invalidating the cards in the plurality of financial institutions and the way of dealing with the procedures by the financial institutions, it may take much time to carry out management for invalidating the cards.

On the other hand, JP-A-2000-4295 discloses such a method that, when a user loses a commutation ticket or a credit card, the user calls up a management center by a portable telephone and registers information of the lost ticket or card into a data file so as to prevent any third person from using the thicket or the card illegitimately. In addition, JP-A-2000-4295 also discloses a system for giving a notice of the found card to the phone number of the portable telephone which is registered in advance.

### SUMMARY OF THE INVENTION

JP-A-2000-4295 does not disclose the manner how to carry out the management for invalidating cards specifically in the financial institutions. In addition, there is no suggestion as to a data center or a computer for managing card information in the financial institutions in a lump.

The present invention is to provide a data center and a management method for managing card information in financial institutions in place of a user on the basis of a request of the user.

In addition, the present invention is to provide a method for managing card information to carry out management of invalidating cards to a plurality of financial institutions on the basis of instructions from a user.

In addition, the present invention is to provide a card management system for managing personal card information uniformly to manage information about cards in a lump.

According to the present invention, card information is managed in a data center interposed between a plurality of financial institutions which issue cards and users which use the issued cards.

The data center registers card information, including card numbers and card status information, into a database correspondingly to user IDs established in advance. The data center checks a user ID transmitted from a terminal operated by a user, with each of the user IDs registered in the database. If a registered user ID is coincident with the transmitted user ID as a result of the checking, the data center invalidates status information contained in card information corresponding to the cards selected by the user. Then, the data center transmits a request of invalidating the selected cards to financial institutions issuing the selected cards, while designating card numbers of the selected cards.

### BRIEF DESCRIPTION OF THE DRAWINGS

FIG. 1 shows the configuration of a network system for carrying out card management according to an embodiment of the present invention;

FIG. 2 shows a format of a card data table in a card management database;

FIG. 3 is a data format of a database 312 in a financial institution 3;

FIGS. 4A to 4C are views showing examples of screens displayed on a PC which is a user's terminal;

FIG. 4A shows an example of selection screen;

FIG. 4B, an example of termination screen; and

FIG. 4C, an example of deletion screen;

FIG. 5 shows a management flow chart for carrying out management of invalidating card information;

FIG. 6 shows a flow chart for registering card information into a card management database 12 of a card information management company; and

FIG. 7 shows a flow chart for deleting data from the card management database 12 of the card information management company.

### DETAILED DESCRIPTION OF THE EMBODIMENTS

Embodiments of the present invention will be described below in detail with reference to the drawings.

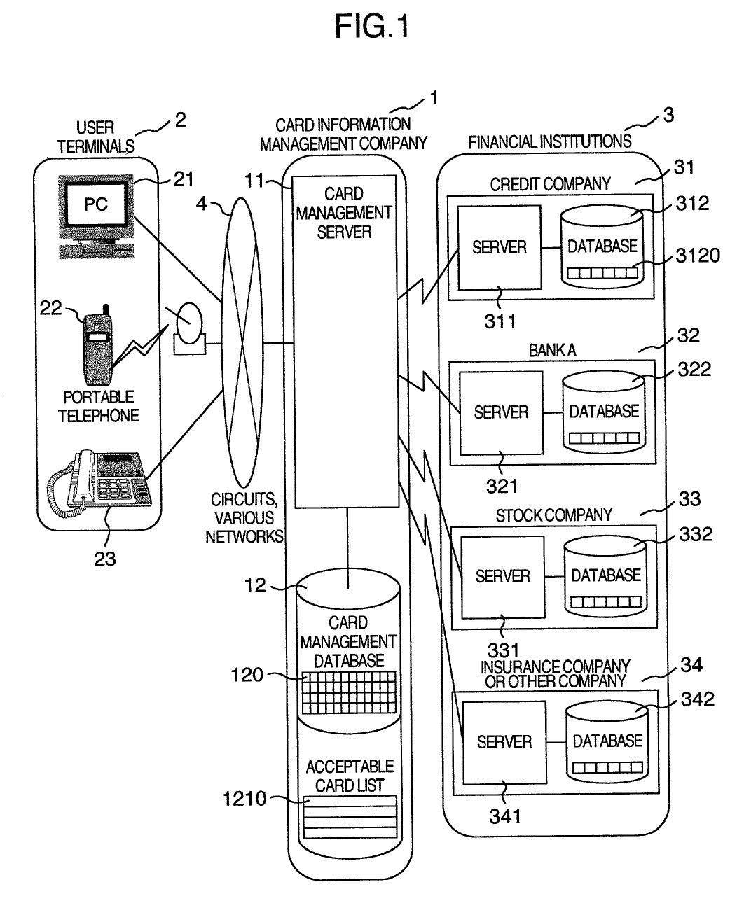

FIG. 1 is a diagram showing the configuration of a network system for carrying out card management according to an embodiment of the present invention.

The network system is constituted by a card information management company 1, user terminals 2, and financial institutions 3 which carry out issue, registration/deletion, and settlement of cards. The card information management company 1, the user terminals 2 and the financial institutions 3 are connected through communication means such as a network like Internet, a public network, a private network, etc. The card information management company 1 and the user terminals 2 are connected through a network 4 such as a public network, Internet, or the like, while the card information management company 1 and the financial institutions 3 are connected through leased lines in consideration of security.

Description will be made about the respective constituent members of the system. The user terminals 2 are apparatuses including a personal computer (hereinafter abbreviated to “PC”) 21, a portable telephone 22, a domestic push-button telephone 23, other portable terminals (not shown), etc. Preferably, each of the user terminals 2 has an input portion through which information is inputted by user's operation, and a display portion for displaying information. Explanation for information management in accordance with a flow chart, which will be described later, is made on the assumption that the PC 21 is used.

The card information management company 1 has a card management server (hereinafter referred to as “management server” simply) 11 for managing card information, and a card management data table 12 for managing a card data table 120 in which card information of a large number of users has been registered. The card information management company 1 functions as a data center or a computer center for managing card information. The idea of such a card information management company 1 is proposed chiefly in the present invention. The card information management company 1 is interposed between the users and the financial institutions 3 so as to manage card information in the financial institutions 3 in place of the users. For example, the card information management company 1 carries out management for invalidating cards.

The financial institutions 3 are companies which issue cards to users and permit the users to make various transactions with the cards. The financial institutions 3 include a credit company 31, a bank 32, a stock company 33, and an insurance company 34. The companies 31 to 34 have servers 311, 321, 331 and 341 for managing card information, and databases 312, 322, 332 and 342 for registering card information 3120 of users, respectively.

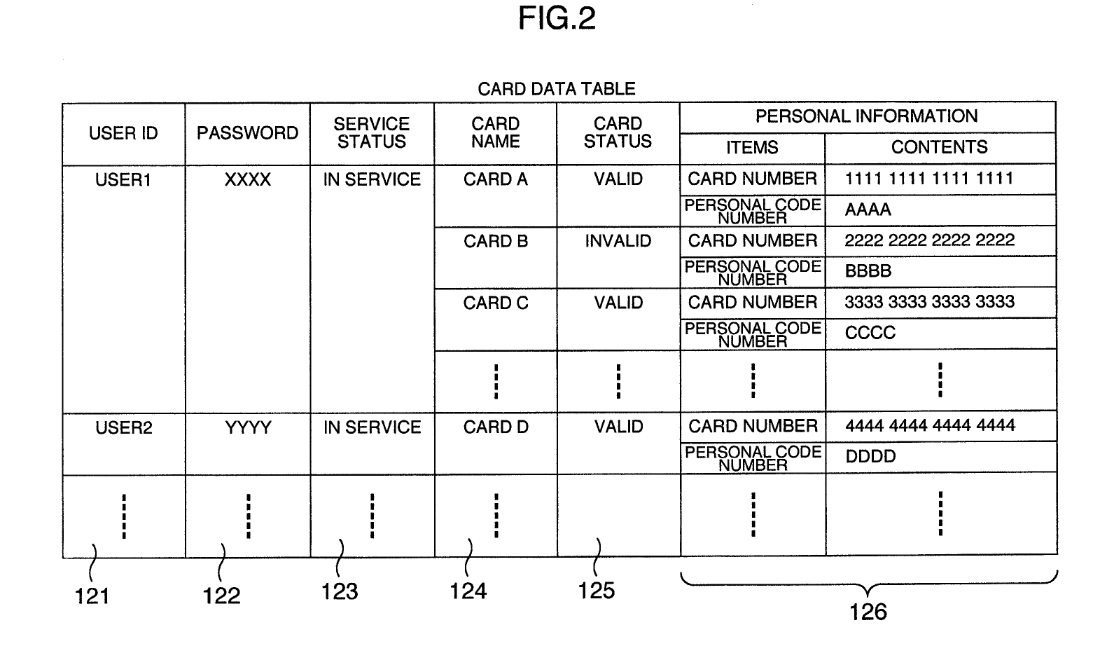

FIG. 2 shows a data format of the card data table 120 stored in the card management database 12. Card data for each user is registered in the card data table 120. Card data for each user is constituted by a user ID 121, a password 122, a card service status 123, a card name 124, a card status 125, and personal information 126.

The user ID 121 is a number, for example, a four-digit number established on the basis of the agreement between the user and the card information management company 1. The use ID 121 is used as a key for personal retrieval of the user in the server 11. The password 122 is a secret number set by the user and is used for personal authorization of the user in the card information management company 1. The information 123 showing the card service status represents confirmation as to whether the card is permitted to receive service of the card information management company 1 or not. The information 123 ordinarily represents “in service”. However, as it will be described later, if an incorrect password 122 is shown repeatedly at a predetermined number of times, the card information management company 1 regards the user as illegitimate. Thus, the user cannot receive service from the card information management company 1. In such a case, the status information 123 represents “service rejected”. The card name 124 designates the name of the card issued by the financial institution 3. The card status 125 is a flag indicating whether the card owned by the user is valid or invalid. The card status 125 ordinarily represents “valid”, that is, flag “1” in the condition that the card can be accepted. However, in such a case that payment with the card is suspended, the card status 125 represents “invalid”, that is, flag “0”. The personal information 126 is additional information provided when the user makes an agreement with the financial institution 3 such as the credit company 31 or the like. For example, the personal information 126 includes a 16-digit card number and a 4-digit personal code number. The card information registered in the card data table 120 is overlapped only in the personal information 126 with the information 3120 registered in the database 312 of the financial institution 3, or the like. Accordingly, the quantity of the card information registered in the card data table 120 is much smaller than that of information owned by the financial institutions 3. This is because the card information management company 1 does not have to own copies of all the information owned by the financial institutions 3. In addition, it is taken into consideration that information against the privacy of the user is prevented from spreading.

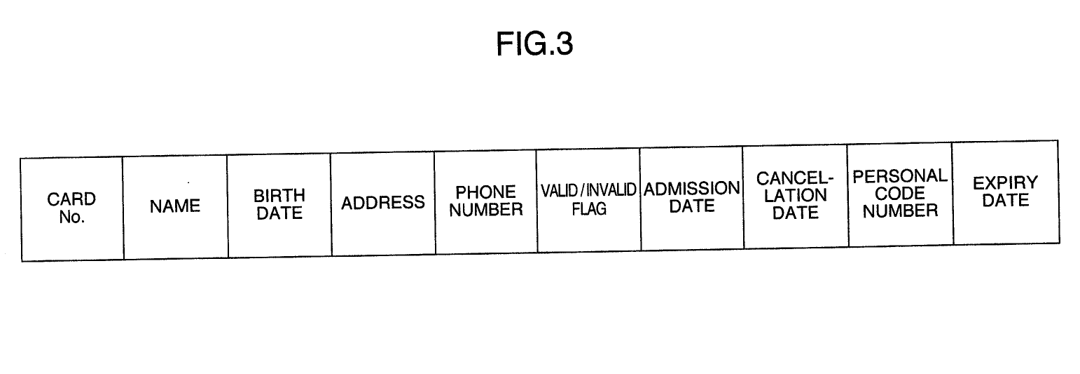

FIG. 3 is a diagram showing an example of data format of the card information 3120 stored in each of the databases 312 to 342 of the financial institutions 3. In this case, an example of format of a credit company is shown. Fundamentally, the card information 3120 includes substantially all the information written in the contract when the user made an agreement with the credit company 31. For example, the card information 3120 includes 16-digit card number, name, date of birth, address, phone number, valid/invalid flag, date of admission, date of cancellation, 4-digit personal code number, and expiry date of the card. Generally, the valid/invalid flag designates valid “1” when transactions made with the card are carried out regularly. On the other hand, the valid/invalid flag designates invalid “0” when transactions made with the card are or have been suspended.

In the case of the credit company, the 16-digit card number is designed to include an identification number of the credit company, and a card identification number which differs from any other card. On the other hand, in the case of the bank 32, the card number is of 14 digits, designed to include a 4-digit bank identification number, a 3-digit branch number, and a 7-digit account number.

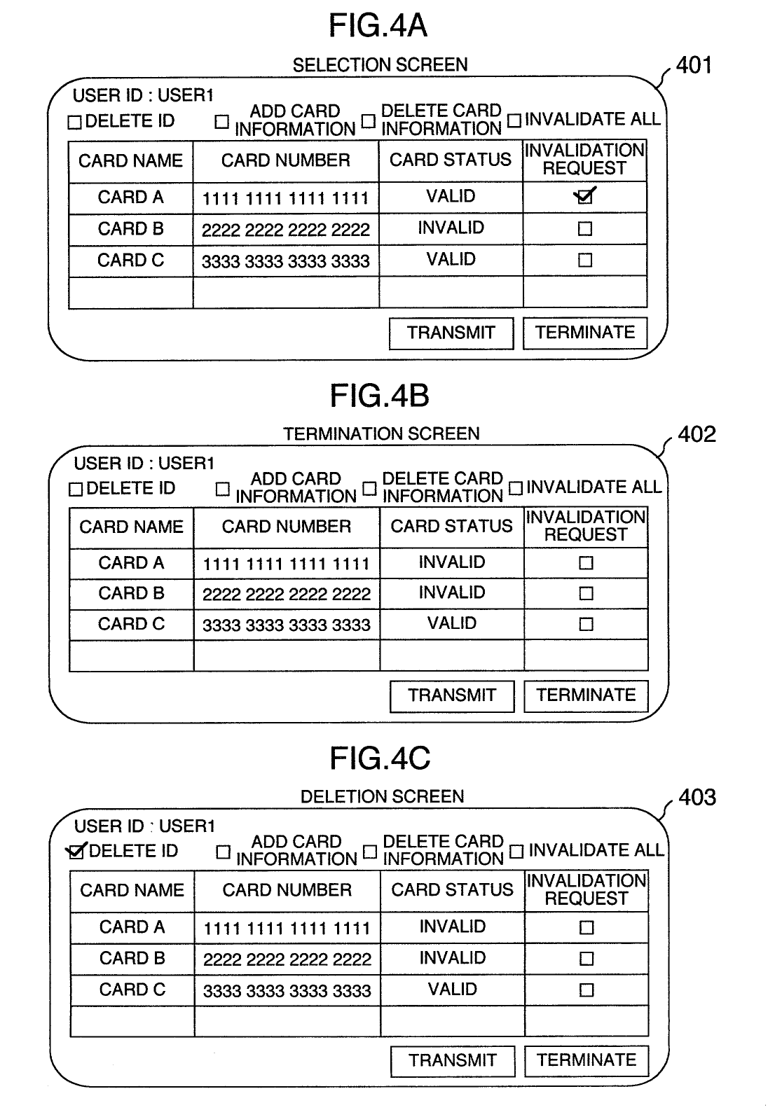

FIGS. 4A to 4C show examples of display of screens in a PC which is a user's terminal 2. FIG. 4A shows an example of display of a selection screen for managing cards. FIG. 4B shows an example of display of a termination screen for card invalidation. FIG. 4C shows an example of display of a screen in the case where some card information is to be deleted from the table.

In the display screen shown in FIG. 4A, check mark items “Delete ID”, “Add Card Information”, “Delete Card Information” and “Invalidate All” are displayed as well as a user ID. In addition, card table items “Card Name”, “Card Number”, “Card Status” and “Invalidation Request” are displayed. In the item “Card Status”, “Valid” is indicated in the condition that the card is in regular use, while “Invalid” is indicated in such a condition that transactions made with the card have been suspended. Further, a key “Transmit” and a key “Terminate” are also displayed. The user operates the user's terminal 2 to input the check mark “γ” into any check mark item or to select (click) any check mark item. Thus, the user can select any item.

For example, when the user wants to invalidate a “Valid” card A, the user operates the user's terminal 2 to input the check mark “γ” into the check mark item “Invalidation Request” or to select (click) the check mark item. Subsequently, the user selects (clicks) the key “Transmit”.

When the management for invalidating the card A is terminated by the card information management company 1 and the financial institution 3, the display screen shown in FIG. 4B is displayed. That is, the status of the card A is displayed to be “Invalid”.

FIG. 4C shows a deletion screen for deleting card information registered in the card information management company 1 by way of example. When the user wants to delete the user ID, the user operates the user's terminal 2 to input the check mark “γ” into the check mark item “Delete ID” or to select (click) the check mark item. Subsequently, the user selects (clicks) the key “Transmit”. When the user wants to delete card information, the user inputs the check mark “γ” into the check mark item “Card Deletion Request” of the desired card or to select (click) the check mark item.

The key “Terminate” is displayed on each of the above-mentioned screens. If the user wants to terminate the operation, for example, if the user wants to leave off management, the user may terminate the operation in any stage by selecting (clicking) the key “Terminate”.

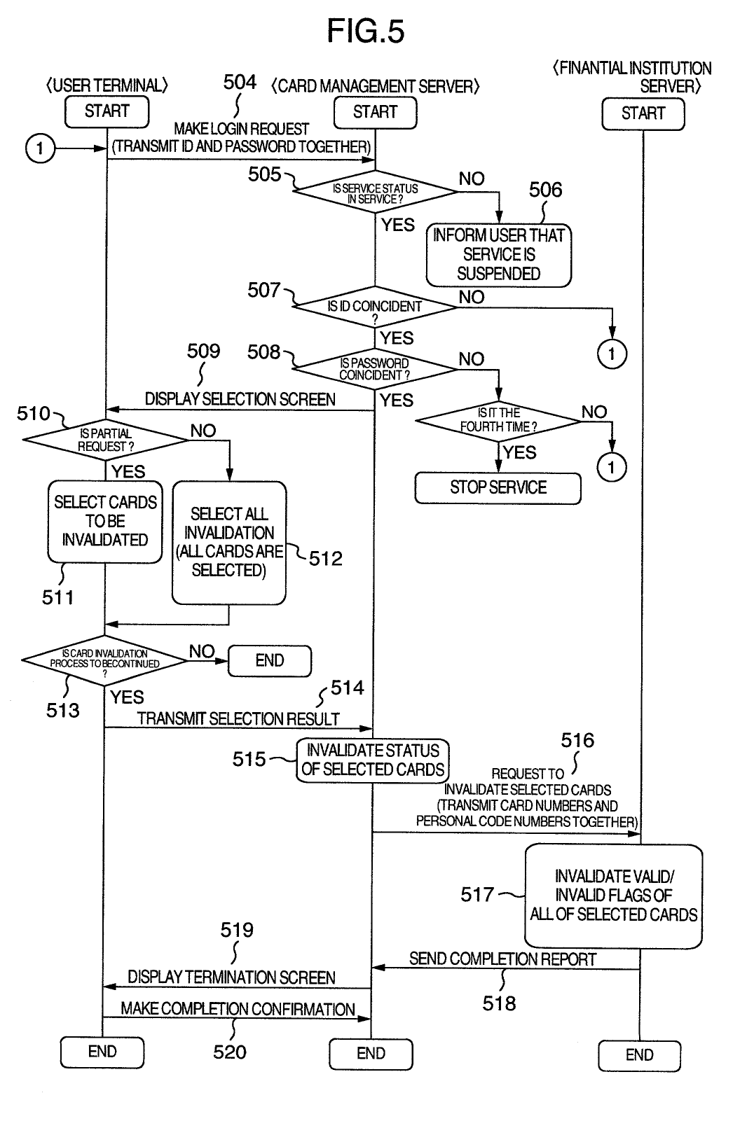

Next, with reference to the flow chart shown in FIG. 5, description will be made about management for invalidating card information in the network system shown in FIG. 1. Incidentally, it is assumed that information of a plurality of cards to be managed on the basis of the agreement between the user and the card information management company 1 has been already registered in the card management database 12. For example, the user who has registered the card information in the card information management company 1 receives service from the card information management company 1 in such a case that the user wants to cancel a contract about a card with the financial institution 3, or in such a case that the user wants the credit company 31 or the like to carry out management for invalidating a card at once because the user has lost the card. The following management is carried out by executing a program stored in a storage (not shown) in the management server 11.

At the beginning, the user operates the user's terminal 2, for example, the PC 21 to display an initial screen (menu screen) on the display portion of the PC 21 in order to carry out management for adding, deleting or invalidating card information. The initial screen includes at least input sections for a user ID and a password.

In this case, an address such as a domain address, a phone number, or the like, is assigned in advance to the management server 11 of the card information management company 1 in accordance to the kind of the network 4. The user inputs the address of the management server 11 into the user's terminal 2, or selects the address of the management server 11 registered in the user's terminal 2 in advance. Thus, the user makes the user's terminal 2 communicate with the management server 11. Through the network 4, the user's terminal 2 requests the management server 11 to transmit the initial screen. In response to the request from the user's terminal 2, the initial screen is transmitted from the management server 11 to the user's terminal 2 through the network 4. Thus, the initial screen is displayed on the display portion of the user's terminal 2. (The above management is not shown.)

Incidentally, the initial screen may be registered in the user's terminal 2 in advance. In this case, the user selects the initial screen registered in the user's terminal 2 so as to display the initial screen on the display portion. If the user's terminal 2 has no display portion, announcement (vocal guidance) from the management server 11 for urging the user to input the user ID and password is sent back to the user's terminal 2 as soon as the user's terminal 2 comes into communication with the management server 11.

After the initial screen has been displayed on the display portion of the user's terminal 2, for example, on the display portion of the PC 21, the user begins to manage card information. The user operates the input portion of the PC 21 to input the user ID and the password into input sections which are contained in the initial screen, respectively. The information of the user ID and the password is transmitted as a login request from the PC 21 to the management server 11 through the network 4 (504). The management server 11 first judges whether the card service status 123 is in service or not (505). If the card service status 123 is not in service, the management server 11 sends back to the PC 21 a notice that the service is suspended (506). On the other hand, if the card service status 123 is in service, the management server 11 subsequently checks the user ID (507). This check is carried out for identifying the user by comparing the user ID transmitted from the PC 21 with each of the user IDs 121 registered in the card management database 12. As a result of comparison, if the coincident user ID 121 is not registered in the card data table 120, the management server 11 sends the result back to the PC 21, and returns to its initial state. On the contrary, if it is concluded as the result of comparison that the transmitted user ID and the register user ID 121 coincide with each other, the management server 11 subsequently checks the password (508). This check is carried out for judging whether the access to the management server 11 is made based on a request from a legitimate user or not. The check is performed by comparing the password transmitted from the PC 21 with the password 122 registered in the card management database 12. As a result of comparison, if both the passwords do not coincide with each other, the management server 11 urges the user to input the password again. Then, the management server 11 judges whether the check of the password has been carried out four times or not. If the number of times of the password check does not reach four, the management server 11 sends the PC 21 a notice that password check results in not-coincidence, and urges the user to input the password again. The password retransmitted from the PC 21 to the management server 11 is checked in the same manner as above mentioned. This operation is repeated in the management server 11. If password check results in not-coincidence continuously four times, the management server 11 regards the request as not being sent from the legitimate user himself/herself, and stops the service for managing the card information. On the contrary, if the inputted password coincides with the registered password 122 as the result of the password check, the selection screen 401 shown in FIG. 4A is transmitted from the management server 11 to the PC 21 (509). The selection screen 401 is displayed on the display portion of the PC 21.

In the PC 21, the user designates whether management for invalidating card information is carried out on a part or all of the cards registered in the card management database 12 (510). This designation is provided for simplifying the input operation for invalidating all the cards. When the user wants to invalidate all the card information, the user inputs “γ” into the check mark item “Invalidate All” of the selection screen 401 or selects (clicks) the check mark item (512). On the other hand, when the user wants to invalidate card information about a part of the cards, the user inputs “γ” into the check mark items “Invalidation Request” corresponding to desired cards in the card table, or selects (clicks) the check mark items (511). In the case of FIG. 4A, the check mark item “Invalidation Request” for the card A is selected. In the stage where the user has selected some of the check mark items, if the user wants service for invalidating card information, that is, if the user wants to continue the management, the user selects (clicks) the key “Transmit” of the selection screen 401 (513). On the other hand, if the user wants to stop the management, the user selects (clicks) the key “Terminate” (513).

The result of selection about cards which is put into the PC 21 by the user is transmitted to the management server 11 (514). Management for invalidating status of the selected cards is carried out by the management server 11 (515). By this management, the card data table 120 shown in FIG. 2 is updated. For example, in this management, of information about a plurality of cards registered in accordance with the user ID of the user 1, the content of the card status 125 of the card A is rewritten from “Valid” to “Invalid”. After carrying out the management, the management server 11 sends an invalidation request for the selected card (the card A) to the server of the financial institution 3 which issued the card A (516). For example, on the assumption that the credit company 31 has issued the card A, the management server 11 issues an invalidation request for the card A to the server 311. To specify the card to be invalidated, both the card number and the personal code number are transmitted from the management server 11 to the server 311.

In the server 311 of the credit company 31, management for changing the card information 3120 registered in the database 312 is carried out. In this management, the selected card, that is, card information including a card number coinciding with the card number transmitted from the management server 11 is retrieved. Then, of the retrieved card information, the valid/invalid flag shown in FIG. 3 is rewritten to “Invalid” (517). When the management is terminated, the server 311 sends the management server 11 a report that the card invalidation management is completed (518). Then, the server 311 terminates the management.

When the management server 11 receives the completion report, the management server 11 regards the management for invalidating the card information corresponding to the card number shown to the credit company 31 as completed. Then, the management server 11 transmits the termination screen 402 (FIG. 4B) to the PC 21 (519). The termination screen 402 is displayed on the display portion of the PC 21. Thus, the user knows that the invalidation management for the card information has been completed. When the user selects (clicks) the key “Terminate” displayed on the termination screen 402, completion confirmation is transmitted from the PC 21 to the management server 11 (520). Thus, the management in PC 21 is terminated. The management server 11 receives the completion confirmation from the PC 21, and then terminates the management.

Incidentally, completion confirmation may be transmitted from the PC 21 to the management server 11 when the user selects (clicks) either the key “Transmit” or the key “Terminate” displayed on the termination screen 402. Alternatively, as soon as the PC 21 receives the termination screen 402, the PC 21 may transmit completion confirmation to the management server 11 automatically.

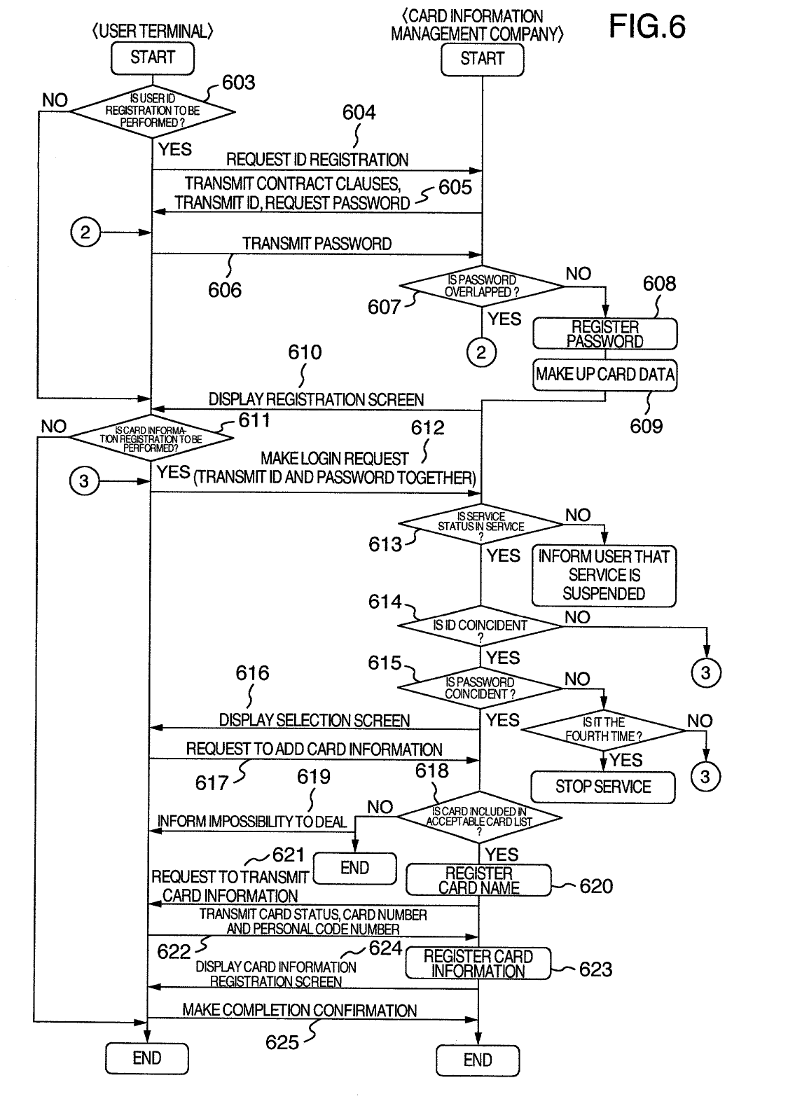

Next, with reference to FIG. 6, description will be made about management for registering card information into the card management database 12 of the card information management company 1. This management is carried out when the user newly requests the card information management company 1 to provide management service of card information. The management includes registration of a user ID and registration of card information into the card management database 12. The following management is carried out by executing a program stored in a storage (not shown) in the management server 11.

First, the user operates the user's terminal 2, for example, the PC 21 to display an initial screen (menu screen) (not shown) on the display portion of the PC 21 in order to carry out management for adding, deleting or invalidating card information. The management for displaying the initial screen (menu screen) on the display portion of the PC 21 is the same as described above. The initial screen includes a check mark item “Register User ID” or a key “Register User ID”.

In the PC 21, it is judged whether the management “Register User ID” has been selected by the user or not (603). That is, it is judged whether the key or check mark item “Register User ID” on the initial screen has been selected (clicked) by the user or not. For example, the management “Register User ID” is not selected when the user ID has been already registered by the user. If the management for “Register User ID” has been selected by the user, a user ID registration request is sent from the PC 21 to the management server 11 through the network 4 (604). In response to the user ID registration request, the management server 11 determines, for example, an 8-digit user ID which is a number proper to the user. At this time, the management server 11 selects a user ID which has not been assigned to any other user. The management server 11 sends the PC 21 agreement clauses, the determined user ID, and a password input request (605). The agreement clauses, the determined user ID, and a password input section are displayed on the display portion of the PC 21. The user reads the contents of the displayed agreement clauses and determines whether to accept them. If the user accepts the agreement clauses, the user operates the input portion of the PC 21 to input, for example, a 4-digit password into the password input section. The inputted password is transmitted from the PC 21 to the management server 11 (606). After then, whenever the user sends a login request, the password will be checked by the management server 11 in order to confirm whether the request is made by a legitimate user or not.

In the management server 11, it is checked whether the received password is coincident with the password of another user already registered in the card management database 12 or not (607). If it is concluded as a result of the check that the received password is coincident with the password of another user, the management server 11 sends a password re-input request to the PC 21. On the other hand, if the password is not coincident with the password of another user, the management server 11 goes to management for registering the received password into the card management database 12 (608). In this management, the management server 11 ensures an area for the user in the card data table 120 in the card management database 12, and makes up card data having the format shown in FIG. 2 (609). Then, the user ID determined for the user and the password inputted by the user are registered into the user ID section 121 and the password section 122 in the card data shown in FIG. 2, respectively. When the user ID and the password have been registered, the management server 11 transmits to the PC 21 a confirmation screen showing the password has been registered (610). The confirmation screen is displayed on the display portion of the PC 21.

Then, when the user wants to register card information newly (611), the user needs to carry out management for a login request and, next, management for input and registration of card information. Because of the need, the registration termination screen includes a user ID input section and a password input section. Alternatively, the user may operate the PC 21 to display the initial screen (menu screen) on the display portion again. The user inputs the user ID and password into the input sections on the displayed screen respectively. The inputted user ID and password are transmitted as a login request from the PC 21 to the management server 11 through the network 4 (612).

The management server 11 judges whether the corresponding card service status 123 is in service or not (613). If the card service status 123 is not in service, the management server 11 transmits to the PC 21 a notice that the service is suspended. On the other hand, if the card service status 123 is in service, the management server 11 subsequently checks the user ID (614). That is, the management server 11 compares the user ID transmitted from the PC 21 with each user ID 121 registered in the card data table 120. As a result of comparison, if the coincident user ID 121 is not registered in the card data table 120, the management server 11 sends a notice of the result back to the PC 21, and urges the user to input the user ID again. On the contrary, if it is concluded as the result of comparison that the coincident user ID 121 exists, the management server 11 subsequently checks the password (615). That is, the management server 11 compares the password transmitted from the PC 21 with the password 122 registered in the card data table 120. As a result of comparison, if both the passwords do not coincide with each other, the management server 11 urges the user to input the password again. Then, the management server 11 judges whether the check of the password has been carried out four times or not. If the number of times of the password check does not reach four, the management server 11 sends the PC 21 a notice that the password is incorrect, and urges the user to input the password again. The password retransmitted from the PC 21 to the management server 11 is checked in the same manner as above mentioned. This operation is repeated in the management server 11. If password check results in not-coincidence continuously four times, the management server 11 regards the request as not being sent from the legitimate user himself/herself, and stops the service for managing the card information. On the contrary, if the inputted password coincides with the registered password 122 as the result of the password check, the selection screen 401 shown in FIG. 4A is transmitted from the management server 11 to the PC 21 (616). The selection screen 401 is displayed on the display portion of the PC 21.

When the user wants to register card information, the user inputs the check mark “γ” into the check mark item “Add Card Information” of the selection screen 401 displayed on the display portion of the PC 21, or selects (clicks) the check mark item. Then, the user inputs necessary information into the section “Card Name” of the selection screen 401. Then, the user selects (clicks) the key “Transmit” of the selection screen 401. The inputted card name and a card name addition request are transmitted from the PC 21 and received by the management server 11 (617).

The management server 11 judges whether the received card name is a card name which can be dealt with by the card information management company 1 or not (618). This judgement is determined based on which financial institutions can have business with the card information management company 1. An acceptable card list 1210 is stored in the card management database 12 of the card information management company 1. Company names of financial institutions and card names which can be dealt with by the card information management company 1 are registered in the acceptable card list 1210. When the card information management company 1 makes a new transaction contract with some company of financial institutions, the company name and the card name of the company are registered in the acceptable card list 1210 newly. The management server 11 checks the received card name with the contents registered in the acceptable card list 1210 (618). If the received card name is a card name which cannot be dealt with by the card information management company 1, the management server 11 gives the PC 21 a notice that the card is not acceptable (619), and terminates the management. On the other hand, if the received card name has been registered in the acceptable card list 1210, the management server 11 registers the received card name into the card name section 124 of the card data in the card data table 121 (620). Then, the management server 11 transmits a card information transmission request to the PC 21 (621). In the PC 21 receiving the card information transmission request, a message for a request of inputting card information is displayed on the display portion. According to the message, the user inputs card information (card status, card number and personal code number) into corresponding sections of the selection screen 401. After that, the user selects (clicks) the key “Transmit” of the selection screen 401. The inputted card information is transmitted from the PC 21 to the management server 11 (622).

The management server 11 receives the card information, and registers the received card information into the card status section 125 and the personal information section 126 of card data in the card data table 120 (623). Here, at the beginning, “Valid” is registered into the card status section. As a result, the user can receive card management service from the card information management company 1 after the registration. “Valid” means that the user can make a financial transaction with the card and the financial institution permits the user to use the card. On the other hand, “Invalid” means that the financial transaction with the card has been or is being canceled, or the financial institution does not permit the user to use the card.

When the management server 11 terminates the registration of the card information, the management server 11 transmits to the PC 21 a confirmation screen showing that the card information has been registered (624). The registration confirmation screen is displayed on the display portion of the PC 21. The user confirms that the card information has been registered, and selects (clicks) the key “Terminate” contained in the screen. Thus, completion confirmation is transmitted from the PC 21 to the management server 11 (625), and the management of the PC 21 is terminated. The management server 11 receives the completion confirmation from the PC 21, and then terminates the management.

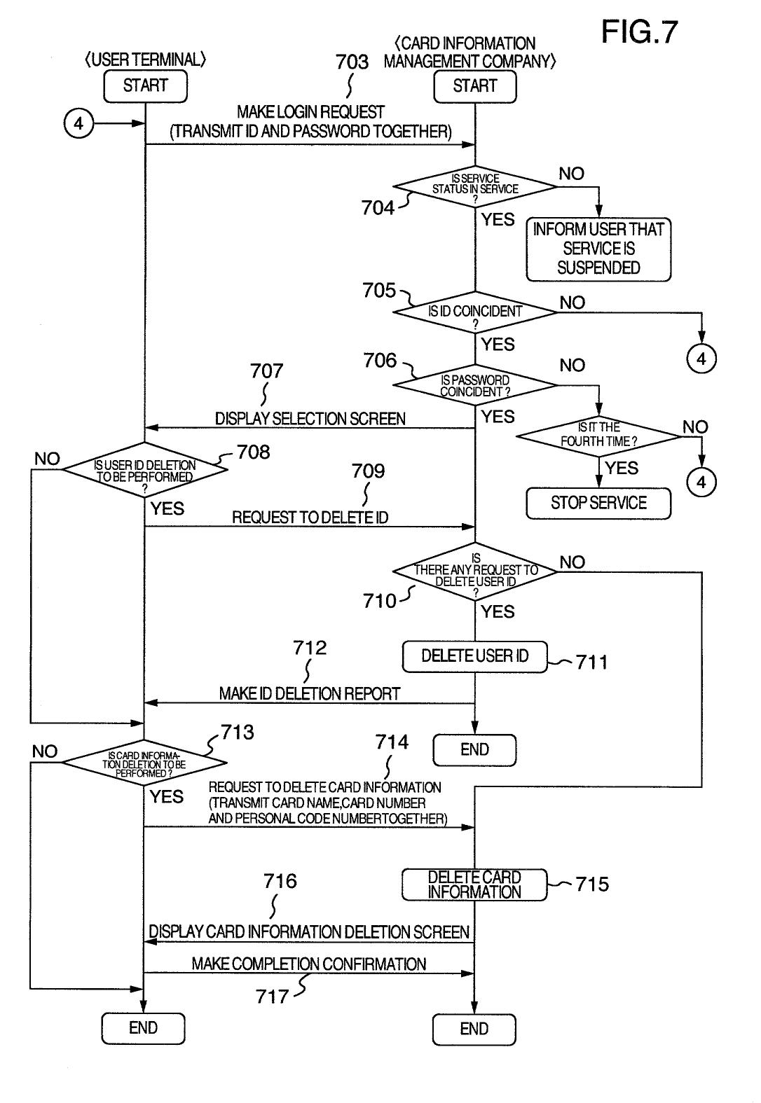

Next, with reference to FIG. 7, description will be made about management for deleting a user ID and card information from the card data table 120.

It is assumed that information about a plurality of cards to be managed by the card information management company 1 at the user's request has been already registered in the card data table 120 of the card management database 12 on the basis of the agreement between the user and the card information management company 1. The user ID is deleted, for example, when the user wants to cancel the agreement with the card information management company 1. On the other hand, the card information is deleted, for example, when the user has canceled a contract about a card with a financial institution so that the user does not have to receive service from the card information management company. The following management is carried out by executing a program stored in a storage (not shown) in the management server 11.

At the beginning, the user operates the user's terminal 2, for example, the PC 21 to display an initial screen (menu screen) (not shown) on the display portion of the PC 21 in order to carry out management for adding, deleting or invalidating card information. The management for displaying the initial screen (menu screen) on the display portion of the PC 21 is the same as described above.

The user operates the input portion of the PC 21 to input the user ID and the password into the input sections contained in the initial screen. The inputted user ID and password are transmitted as a login request from the PC 21 to the management server 11 through the network 4 (703).

The management server 11 judges whether the card service status 123 is in service or not (704). If the card service status 123 is not in service, the management server 11 transmits to the PC 21 a notice that the service is suspended. On the other hand, if the card service status 123 is in service, the management server 11 subsequently checks the user ID (705). That is, the management server 11 compares the user ID transmitted from the PC 21 with each of the user IDs 121 registered in the card data table 120. As a result of comparison, if the coincident user ID 121 is not registered in the card data table 120, the management server 11 sends back to the PC 21 a notice of the result, and urges the user to input the user ID again. On the contrary, if it is concluded as the result of comparison that the coincident user ID 121 exists, the management server 11 subsequently checks the password (706). That is, the management server 11 compares the password transmitted from the PC 21 with the password 122 registered in the card data table 120. As a result of comparison, if both the passwords do not coincide with each other, the management server 11 urges the user to input the password again. Then, the management server 11 judges whether the check of the password has been carried out four times or not. If the number of times of the password check does not reach four, the management server 11 sends the PC 21 a notice that the password is incorrect, and urges the user to input the password again. The password retransmitted from the PC 21 to the management server 11 is checked in the same manner as above mentioned. This operation is repeated in the management server 11. If password check results in not-coincidence continuously four times, the management server 11 regards the request as not being sent from the legitimate user himself/herself, and stops the service for managing the card information. On the contrary, if the inputted password coincides with the registered password 122 as the result of the password check, the selection screen 401 shown in FIG. 4A is transmitted from the management server 11 to the PC 21 (707). The selection screen 401 is displayed on the display portion of the PC 21.

When the user wants to delete the user ID, the user inputs the check mark “γ” into the check mark item “Delete ID” of the selection screen 401 displayed on the display portion of the PC 21, or selects (clicks) the check mark item. Then, the user selects (clicks) the key “Transmit” of the selection screen 401 (708). In response to the selection, a user ID deletion request is transmitted from the PC 21 (709), and received by the management server 11. When the management server 11 recognizes that there is a ID deletion request (710), the management server 11 deletes the user ID from the card data of the user in the card data table 120 (711). Then, the management server 11 transmits to the PC 21 a report that the user ID has been deleted (712). As a result, the user cannot receive service from the card information management company 1.

On the other hand, when the user wants to delete card information, the user inputs the check mark “γ” into the check mark item “Delete Card Information” of the selection screen 401 displayed on the display portion of the PC 21, or selects (clicks) the check mark item. When the check mark item “Delete Card Information” is selected (clicked), it is necessary to select a card to be deleted. Thus, the display content of the selection screen 401 is switched to the display content of the deletion screen 403 shown in FIG. 4C. That is, the display of “Invalidation Request” of the selection screen 401 is switched to “Card Deletion Request”. The user inputs the check mark “γ” into the check mark item “Card Deletion Request” in the deletion screen 403 corresponding to a card to be deleted, or selects (clicks) the check mark item. Then, the user selects (clicks) the key “Transmit” of the deletion screen 403 (713). A deletion request of card information (card name, card number and personal code number) about the card selected by the user is transmitted from the PC 21 to the management server 11 (714).

When the management server 11 receives the deletion request of the card information, the card information (card name, card number and personal code number) about the selected card is deleted from the card data of the user on the card data table 120 (715). Then, the management server 11 transmits to the PC 21 a confirmation screen showing the card information has been deleted (716). The confirmation screen is displayed on the display portion of the PC 21. The user confirms that the card information has been deleted, and selects (clicks) the key “Terminate” contained in the screen. Thus, completion confirmation is transmitted from the PC 21 to the management server 11 (717), and the management of the PC 21 is terminated. The management server 11 receives the completion confirmation from the PC 21, and then terminates the management.

Although an embodiment of the present invention has been described above, the present invention is not limited to the above-mentioned mode, but may be carried out in various modifications. For example, when the user's terminal 2 is a domestic push-button telephone or the like having no display portion, guidance and information to the user are carried out in voice, and instructions and-input from the user are carried out by pushing buttons.

In addition, the format of the card data table 120 registered in the card management database 12 is not limited to the format shown in FIG. 2. For example, the item “Service Status” 123 may be omitted. In addition, any card the item “Card Status” 125 of which is “Invalid” may be managed in another table in accordance with user IDs.

In addition, the selection screen, the termination screen and the deletion screen are not limited to those shown in FIGS. 4A to 4C. For example, the check mark item “Invalidate All” may be omitted. In this case, the user may select all the cards to be invalidated. In addition, only cards the item “Card Status” 125 of which is “Valid” may be displayed on the screen. In addition, the management server 11 may carry out expiry date management for respective cards registered in the card data table 120. In this case, as to any expired card, a notice of expiration is displayed in a note section provided in the selection screen. Alternatively, since such an expired card is out of a target to be managed by the user, information about the card may be automatically set not to be displayed on the screen.

Various modifications may be carried out about the management flow charts in FIGS. 5 to 7. For example, in the card invalidation management shown in FIG. 5, the card invalidation registration (515) to the card data table 120 by the management server 11 may be carried out after the validation completion report (518) from the financial institution is received by the management server.

In addition, cards to be managed are not limited to ones issued by financial institutions. They may include cards issued by supermarkets, department stores, or major electrical stores, or cards associated with any other related institution which generally allows transactions to be made with the cards. In this case, it is necessary that business can be done between the related institution and the card information management company 1.

As has been described, according to the preferable embodiment of the present invention, personal card information is managed in a lump by a data center which uses a server and a database. Then, management of cards can be carried out in a lump in financial institutions at user's request. Further, management for invalidating cards, which are registered correspondingly to users, to a plurality of financial institutions can be carried out immediately in place of the user by the data center.

What is claimed is:

1. A method for managing card information by use of a computer interposed between a plurality of financial institutions which issue cards and users which use the issued cards, said computer having a database, comprising the steps of:
registering card information including card numbers and card status information into said database in accordance with predetermined user IDs;
checking a specified user ID transmitted from a terminal operated by a specified user with each of user IDs registered in said database;
changing said card information to thereby invalidate the card status information contained in the card information corresponding to at least one card selected from said issued cards by said specified user if there is a registered user ID coinciding with said transmitted user ID as a result of said checking step; and
transmitting a request of invalidating said at least one selected card to a financial institution which has issued said selected card while designating a card number of said selected card.

2. A method for managing card information according to claim 1, further comprising the substeps of:
in the step of registering said card information, establishing passwords in advance for said users correspondingly respectively on the basis of agreements with said users, said established passwords being registered in said database;
in the step of checking, checking a password transmitted from said terminal with a corresponding password registered in said database; and
in the step of changing said card information, of information registered in said database, transmitting card information corresponding to said transmitted user ID to said terminal if said transmitted password is coincident with said correspondingly registered password as a result of said password checking.

3. A method for managing card information according to claim 1, further comprising the substeps of:
in the step of changing said card information, transmitting the card information corresponding to said transmitted user ID and including at least one card name, a card number and card status information to said terminal, and receiving a card name of at least one card selected from said transmitted card information by said specified user and a request of invalidating card status information of said selected card from said terminal.

4. A method for managing card information according to claim 1, further comprising the substeps of:
in the step of registering card information into said database, registering passwords established for users correspondingly respectively, card names desired to be registered by users in advance, and personal code numbers necessary for using cards as card information;
in the step of checking, checking a password transmitted from said terminal with a corresponding password registered in said database, and if said transmitted password is coincident with said correspondingly registered password as a result of said password checking, transmitting card information corresponding to said transmitted user ID and including at least one card name, a card number and card status information to said terminal;
in the step of changing said card information, if said transmitted password is coincident with said correspondingly registered password as a result of said password checking, transmitting said card information corresponding to said transmitted user ID and including at least one card name, a card number and card status information to said terminal, receiving a card name of at least one card selected from said transmitted card information by said specified user and a request of invalidating card status information of said selected card from said terminal, and invalidating said card status information of said selected card; and
in the step of transmitting said request, transmitting the card number of said selected card, a personal code number, and said request of invalidating said selected card to a financial institution which has issued said selected card.

5. A method for managing card information according to claim 1, further comprising the substeps of:
in the step of registering said card information, establishing passwords in advance for said users correspondingly respectively on the basis of agreements with said users, said established passwords being registered in said database;
in the step of checking, checking a password transmitted from said terminal with a corresponding password registered in said database; and
in the step of changing said card information, of information registered in said database, transmitting card information corresponding to said transmitted user ID to said terminal if said transmitted password is coincident with said correspondingly registered password as a result of said password checking, receiving from said terminal a card name of at least one card selected from said transmitted card information by said specified user and a request of deleting card information of said selected card or of invalidating card status information of said selected card, or a request of adding new card information, and changing said card information according to said received request.

6. A data center interposed between a plurality of financial institutions which issue cards and users which use the issued cards so that said data center takes procedures about said cards to said plurality of financial institutions in place of said users, comprising:
a database for storing card information, said database storing a card table in which card information is registered, said card information including user IDs established correspondingly respectively for said users in advance on the basis of agreements with said users, card numbers of cards, and information representing status of said cards; and
a server connected to said database for managing said card information, said server being connected through communication means to other servers which are provided in said financial institutions respectively and terminals which can be operated by said users respectively;
wherein said server for managing card information checks a user ID transmitted from any one of said terminals, with each of said user IDs registered in said card table; wherein said server transmits to said terminal card information corresponding to said transmitted user ID, among said information registered in said card table, on the basis of a result of said checking; wherein said server receives from said terminal information about at least one card selected from said transmitted card information by specified one of said users and a request of changing card information of said selected card; wherein said server changes card information of said selected card registered in said card table in accordance with said changing request; and wherein said server transmits, to a financial institution which has issued said selected card, a card number of said selected card and said request of changing card information of said selected card.

7. A data center according to claim 6, wherein:
passwords are established corresponding respectively in advance for users on the basis of agreements between said users and said data center;
said card information registered in said card table further includes said passwords; and
said server checks a password transmitted from said terminal with a corresponding password registered in said database, and if said transmitted password is coincident with said corresponding registered password as a result of said checking step, said server transmits to said terminal card information corresponding to said transmitted user ID, among said card information registered in said card table.

8. A data center according to claim 6, wherein:
said card information registered in said card table includes a card name of at least one card.

9. A data center according to claim 6,
wherein said card information registered in said card table includes passwords established correspondingly and respectively for users, card names desired to be registered by said users in advance, and personal code numbers for using said cards respectively;
wherein, if said user ID transmitted from said terminal coincides with said user ID registered in said card table, said server checks a password transmitted from said terminal with a corresponding password registered in said database, and if said transmitted password is coincident with said registered password as a result of said checking, said server transmits to said terminal at least one card name, a card number and card status information of said card information corresponding to said transmitted user ID; and
wherein, if a card name of at least one card selected by said specified user and a request of invalidating card information of said selected card are received by said server, status information of said selected card contained in said card information registered in said card table is invalidated, and said card number of said selected card and a request of invalidating said selected card are transmitted to a financial institution which has issued said selected card.

10. A data center according to claim 6,
wherein, from said terminal, said server receives a request to delete card information of said selected card or to invalidate card status information of said selected card as a request to change card information of said selected card, or a request to add card information of a new card; and
wherein said server deletes said card information of said selected card from said card table, or invalidates said card status information of said selected card, or adds said card information of said new card to said card table in accordance with said received request.

11. A data center according to claim 6, wherein:
said database further stores a list about cards which have been issued by any of said plurality of financial institutions; and
said server judges whether card information received from said terminal is card information about a card registered in said list or not, and if said received card information is card information about a card registered in said list, said server registers said received card information into said card table.

12. A method for managing card information in a data center having a database, comprising the steps of:
registering card information for users concerning cards issued to said users by at least one card issuing institution;
judging whether a request transmitted from a terminal operated by a specified user to said data center through communication means is a request from a legitimate user or not;
transmitting card information about at least one card of said specified user if said transmitted request is a request from a legitimate user;
changing card information about at least one card designated by said specified user to be registered in said database in accordance with a changing request from said specified user if said request of changing the card information about said designated card is transmitted from said terminal; and
transmitting, through communication means, said request of changing the card information about said designated card to a card issuing institution which has issued said designated card.

13. A method for managing card information in a system constituted by: a plurality of financial institutions which issue cards to users and which have databases for registering card utilization information of said respective users correspondingly to card numbers including numbers proper to said users respectively; a card information management company having a card management database in which information about cards issued by said plurality of financial institutions has been registered in accordance with user IDs given correspondingly and respectively to specified users who want said card information management company to manage card information of said specified users, and a computer for managing said card information of said specified users; and terminals of said specified users connected to said computer of said card information management company through a network; comprising the steps of:
from any one of said terminals,
transmitting a user ID;
selecting service about card information registered in said card management database;
in said computer,
checking said user ID transmitted from said terminal with each of said user IDs registered in said card management database;
changing card information of said card management database corresponding to said user ID if there is a registered user ID coinciding with said transmitted user ID as a result of said checking step;
transmitting information about said card information required to be changed to corresponding one of said financial institutions; and
in said corresponding financial institution,
changing information corresponding to said card information transmitted from said computer, among information registered in a database of said financial institution.

14. A method for managing card information according to claim 13, wherein:
said plurality of financial institutions are credit companies, banks, stock companies or insurance companies, said card numbers are credit numbers or numbers including numbers proper to financial institutions and account numbers, and card numbers of cards selected by said users are registered in said card management database and are associated with user IDs of said specified users, respectively.

15. A method for managing card information according to claim 13, wherein:
passwords are established correspondingly respectively for said users in advance on the basis of agreements between said card information management company and said specified users, and said passwords are registered in said card management database correspondingly to said user IDs respectively;
a password inputted by one of said specified users is transmitted from corresponding one of said terminals; and
said transmitted password is checked in said computer, with a corresponding password registered in said card management database, and only if said transmitted password and said correspondingly registered password coincide with each other as a result of said checking, said card information management company provides service to said specified user.

16. A method for managing card information according to claim 13, wherein:
in said computer, card information corresponding to a user ID transmitted from said terminal, and including at least one card name, a card number and card status information is transmitted to said terminal; and
in said terminal, said card information is displayed on a display portion of said terminal, and an instruction to select at least one card name from said card information displayed on said display portion and an instruction to change card status information are inputted through an input portion of said terminal by operation of said specified user.

17. A method for managing card information according to claim 13, wherein:
in said card information management company, card information is registered into said card management database, said card information corresponding to said user IDs and including passwords which differ from one user to another, card names and card numbers of cards designated by said specified users, and information representing status of said cards;
from any one of said terminals, information about at least one card designated by corresponding one of said specified users is transmitted;
in said computer, information representing card status contained in card information corresponding to said card is rewritten to be invalid, said card being designated by said specified user out of said card information registered in said card management database, and information to invalidate said card is transmitted to a financial institution which has issued said card designated by said specified user.

18. A method for managing card information according to claim 15, wherein:
in said card information management company, card information is registered into said card management database, said card information corresponding to said user IDs and including passwords which differ from one user to another, card names and card numbers of cards designated by said specified users, and information representing status of said cards;
said computer checks a password registered in said card management database with a password transmitted from said terminal; if said registered password and said transmitted password coincide with each other as a result of said checking, said computer allows said specified user to select at least one card name and to input for invalidating status of a selected card through said terminal; and said computer rewrites said card information registered in said card management database so as to invalidate information representing status of said card selected by said specified user out of card information of said specified user.

19. A card management system comprising:
financial databases for registering first card information, said first card information being associated with transactions made with cards and including card numbers having numbers proper to individuals, and flags indicating whether said cards are valid or invalid, respectively;
servers of a plurality of financial institutions connected to said financial database for managing said first card information;
a card management database for storing a card table, said card table having second card information registered in said card table, said second card information including user IDs differing from one user to another, card numbers of financial institutions designated by users, and information representing validity status of cards;
a management server connected to said servers of said plurality of financial institutions for managing said second card information; and
terminals for said users connected to said management server through communication means;
wherein:
one of said terminals for corresponding one of said users transmits, to said management server, information about at least one card selected by said corresponding user to be invalidated, out of said second card information registered in said card management database;
said management server compares each of said user IDs registered in said card management database, with a user ID transmitted from said terminal for said user; said management server invalidates said information representing validity status of said card designated by said user out of said second card information on the condition that there is a registered user ID coinciding with said transmitted user ID; and said management server transmits, to a server of a corresponding and related financial institution, a card number of said designated card and information to invalidate said card; and
said server of said related financial institution gains access to a corresponding financial database, and invalidates a flag in said first card information corresponding to said card number transmitted from said management server, respectively.
